(19) United States
(12) Patent Application Publication
(10) Pub. No.: US 2003/0213654 A1
(43) Pub. Date: Nov. 20, 2003

(54) Elevator signal transmission system reducing the number of lines

(75) Inventor: Hirokazu Higuchi, Miyagi-ken (JP)

Correspondence Address: Brinks Hofer Gilson & Lione, P.O. Box 10395, Chicago, IL, 60610, US

(73) Assignee: ALPS ELECTRIC CO., LTD.

(21) Appl. No.: 10/440,774

(22) Filed: May 19, 2003

(30) Foreign Application Priority Data
May 20, 2002 (JP) 2002-145087

(51) Int. Cl. B66B 3/00

(52) U.S. Cl. 187/391

(57) ABSTRACT

An elevator signal transmission system includes a monitor camera and an interphone equipped with a camera each being arranged inside an elevator cage, a power source line for supplying driving power to the cage, and a transmitter/receiver provided to the cage and connecting the monitor camera and the interphone equipped with the camera to the power source line wherein the transmitter/receiver causes power source line to transmit transmission signals from the monitor camera and from the interphone equipped with the camera and supplies reception signals received from the power source line to the interphone equipped with the camera.

### BACKGROUND OF THE INVENTION

1. Field of the Invention

This invention relates to an elevator signal transmission system. More particularly, the invention relates to an elevator signal transmission system for conducting transmission and reception of information signals exchanged between an elevator cage and an elevator monitor section through a power source line for supplying driving power to the cage.

2. Description of the Related Art

A monitor camera and an interphone are generally provided to an elevator cage to monitor a maintenance condition inside the cage and to establish communication between the cage and outside in case of emergency. In this case, the monitor camera periodically images the condition inside the elevator cage and transfers image signals so obtained to an elevator monitor section so that the monitor section can minutely grasp the condition inside the cage. When the supply of power to the cage is interrupted for some reason or other, the interphone enables a passenger or passengers confined in the cage to communicate with the elevator monitor section.

FIG. 3 is a transverse sectional view showing an example of a condition of such an elevator cage and surrounding portions. Equipment other than the monitor camera and the interphone provided inside the cage is omitted from the drawing.

As shown in FIG. 3, a monitor camera 32 is arranged in an upper region of one of the corners on the door side of an elevator cage 31 at an angle such that it can image the inside of the cage 31. An interphone 33 equipped with an emergency button is fitted to the sidewall in the proximity of the other corner portion of the cage 31 on the door side at a height corresponding to that of passengers. A line bundle 34 including a power source line (without reference numeral) for supplying power to the cage 31, a control line (without reference numeral) for transferring a control signal for operating each part of the cage 31, transmission lines 35(1) and 35(2) for transferring communication information between the cage 31 and an elevator monitor section (without reference numeral), and so forth, is provided to outside portion of the cage 31. In this case, the monitor camera 32 is connected to one 35(1) of the transmission lines through a connection line, and monitor signals are exchanged between the monitor camera 32 and the elevator monitor section through this transmission line 35(1). The interphone 33 is connected to the other transmission line 35(2) through a connection line, and communication signals (speech signals) are exchanged between the interphone 33 and the elevator monitor section through this transmission line 35(2).

Incidentally, the line bundle 34 is so constituted as to move up and down with the up/down movement of the cage 31. Therefore, the power source line, the control line, the transmission lines 35(1) and 35(2), and so forth have a certain margin of length so that they are not affected by the up/down movement of the cage 31. Moreover, these lines are constituted so that they are not broken or cut off even when they are bent and extended a large number of times.

The known elevator cage 31 described above uses one transmission line 35(1) for transmitting the monitor signals between the monitor camera 32 and the elevator monitor section and another transmission line 35(2) for transmitting the communication signals between the interphone 33 and the elevator monitor section. Therefore, at least two transmission lines 35(1) and 35(2) must be assembled into the line bundle 34.

In contrast, the line bundle 34 has a certain margin of length lest it is affected by the up/down movement of the cage 31 and is so constituted as not to be broken or cut off against bending that is made a large number of times, as described above. Therefore, the line bundle 34 becomes expensive as a whole when the power source line, the control line and the transmission lines 35(1) and 35(2) having such characteristics are used, and the installation cost of the elevator becomes high as much.

To reduce the installation cost of the elevator, an attempt has been made to use transmission of wireless signals or transmission of optical signals in place of transmission of the monitor signals and the communication signals through the transmission lines 35(1) and 35(2). However, because the elevator cage always moves up and down, transmission of the wireless signals and the optical signals cannot be conducted stably, and signal transmission cannot be made under the state where satisfactory signal quality is maintained.

### SUMMARY OF THE INVENTION

In view of the technical background described above, this invention aims at providing an elevator signal transmission system that can reduce the number of lines of a line bundle by using a power source line used for an elevator cage also as a transmission line, can thus reduce a production cost and can transfer signals having stable quality.

To accomplish the object described above, the invention provides an elevator signal transmission system comprising a monitor camera and an interphone equipped with a camera, each arranged inside an elevator cage; a power source line for supplying driving power to the cage; and a transmitter/receiver for connecting the monitor camera and the interphone equipped with the camera to the power source line; wherein the transmitter/receiver causes the power source line to transmit transmission signals from the monitor camera and from the interphone equipped with the camera, and supplies reception signals received from the power source line to the interphone equipped with the camera.

According to the means described above, the monitor camera and the interphone equipped with the camera are connected to the power source line through the transmitter/receiver and the power source line is used also as the transmission line. In this case, the transmitter/receiver causes the power source line to transmit the transmission signals from the monitor camera and from the interphone equipped with the camera, and supplies the reception signals received from the power source line to the interphone equipped with the camera. Therefore, at least the transmission line can be omitted from the line bundle, and the production cost of the line bundle, hence the production cost of the elevator, can be lowered as much, and high quality signal transmission can be conducted.

### BRIEF DESCRIPTION OF THE DRAWINGS

FIG. 1 is a structural view showing an outline of an elevator signal transmission system according to the invention and is a transverse sectional view showing a condition of an elevator cage and its surrounding portion;

FIG. 2 is a block diagram showing an example of a concrete construction of a transmitter/receiver shown in FIG. 1; and

FIG. 3 is a transverse sectiona 1 view showing an example of a condition of a known elevator cage and its surrounding portion.

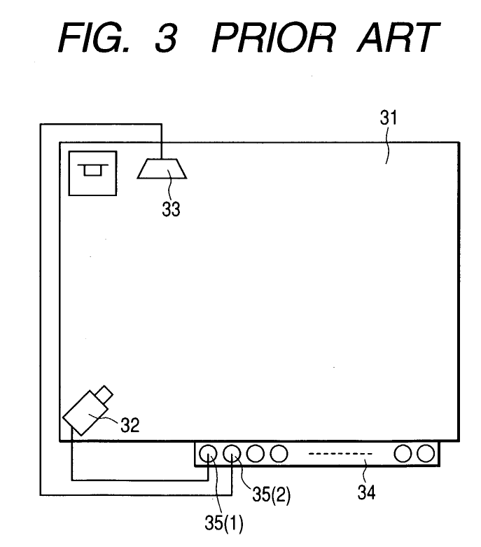

### DESCRIPTION OF THE PREFERRED EMBODIMENT

A preferred embodiment of the invention will be explained with reference to the accompanying drawings.

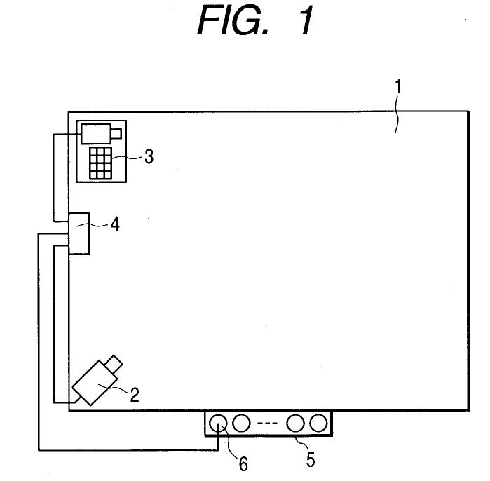

FIG. 1 is a structural view showing an outline of an elevator signal transmission system according to the invention and is a transverse sectional view showing a condition of an elevator cage and its surrounding portion. Incidentally, equipment other than a monitor camera and an interphone inside the cage is omitted from FIG. 1, too.

A monitor camera 2 is provided to an upper region of one of corner portions on the door side of the elevator cage 1 according to the embodiment at an angle such that the monitor camera 2 can image the inside of the cage 1 as shown-in FIG. 1. An interphone 3 equipped with a camera is fitted to the sidewall in the proximity of the other corner portion of the cage 1 on the door side at a height corresponding to that of passengers. A line bundle 5 including a power source line 6 for supplying power to the cage 1, a control line (without reference numeral) for transferring a control signal for operating each part of the cage 1, and so forth, is provided to the outside portion of the cage 1. In addition, a transmitter/receiver 4 is provided to the elevator cage 1 between the monitor camera 2, the interphone 3 and the power source line 6. In this case, the monitor camera 2 and the interphone 3 are connected to the transmitter/receiver 4 through a connection line (without reference numeral) and the power source line 6 is connected to the transmitter/receiver 4 through a connection line (without reference numeral).

The image signals imaged by the monitor camera 2 are once converted to digital data in the transmitter/receiver 4 and the digital data so converted are again converted to analog signals. The analog signals so converted are supplied from the transmitter/receiver 4 to the power source line 6 and are transferred to the elevator monitor section, etc, through the power source line 6. Image signals imaged by the interphone 3 and/or speech signals detected by the interphone 3 are similarly converted once to digital data in the transmitter/receiver 4 and the digital data so converted is again converted to analog signals. The analog signals so converted are supplied from the transmitter/receiver 4 to the power source line 6 and are transferred to the elevator monitor section, etc, through the power source line 6. When supplied from the power source line to the transmitter/receiver 4, the analog signals supplied from the elevator monitor section, etc, through the power source line 6 are once converted to digital data in the transmitter/receiver 4 and the digital data so converted is again converted to analog signals. The analog signals so converted are supplied to the interphone 3 and are from thence emitted as sound. In this case, the transmission rate of the digital data formed in the transmitter/receiver 4 is selected to be several mega-bits per second (Mbps).

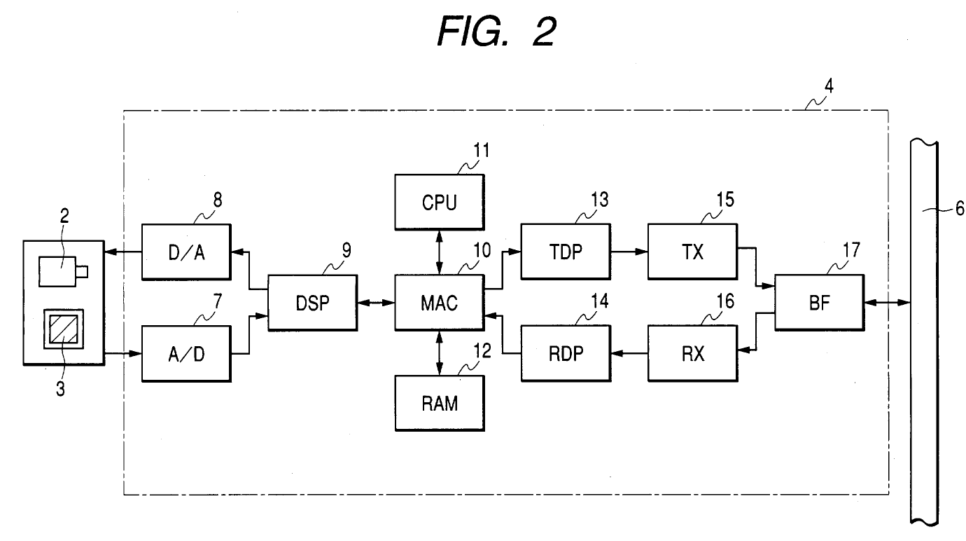

Next, FIG. 2 is a block diagram showing an example of a concrete construction of the transmitter/receiver 4 shown in FIG. 1.

In FIG. 2, the same reference numeral and sign is used to identify the same constituent element as in FIG. 1.

As shown in FIG. 2, the transmitter/receiver 4 includes an analog/digital conversion portion (A/D) 7 for converting an input analog signal to digital data and outputting the digital data, a digital/analog conversion portion (D/A) 8 for converting input digital data to an analog signal and outputting the analog signal, a digital signal processor (DSP) 9 for mutually converting digital data and stream data, a multimedia access control portion (MAC) 10 for generating transmission serial data and checking reception serial data, a control portion (CPU) 11 for collectively controlling each part of the transmitter/receiver 4, a storage portion (RAM) 12 from which storage data is read out when transmission serial data is generated, a transmission data processor (TDP) 13 for executing various processes of the transmission serial data, a reception data processor (RDP) 14 for executing various processes of reception serial data, a data transmission portion (TX) 15 for converting transmission serial data to an analog signal and outputting the analog data, a data reception portion (RX) 16 for converting the analog signal to reception serial data, and a buffer (BF) portion 17 for transmitting and receiving the analog signal to and from the power source line 6.

The transmitter/receiver 4 having the construction described above operates in the following way.

When an imaging timing of the monitor camera 2 is reached, the monitor camera 2 images the inside of the elevator cage 1, outputs the image signal so imaged and supplies the image signal to the transmitter/receiver 4. At this time, the analog/digital conversion portion 7 in the transmitter/receiver 4 converts the image signal to digital data having a transmission rate of several Mbps and supplies the digital data so converted to the digital signal processor 9. The digital signal processor 9 converts the digital data supplied thereto to stream data and supplies the stream data so converted to the multimedia access control portion 10. The multimedia access control portion 10 generates transmission serial data from the stream data supplied and supplies the transmission serial data so generated to the transmission data processor 13. The transmission data processor 13 executes error correction and adjustment of a power level of the transmission serial data supplied, and supplies the transmission serial data to the data transmission portion 15. The data transmission portion 15 executes digital/analog conversion of the transmission serial data supplied, generates a transmission analog signal and transmits and supplies the resulting transmission analog signal to the power source line 6 through the buffer portion 17. The transmission analog signal supplied to the power source line 6 is thereafter supplied to the elevator monitor section through the power source line 6.

When the interphone 3 is operated and supplies the image signal and/or the communication signal (speech signal) to the transmitter/receiver 4, too, the transmitter/receiver 4 operates in the same way as described above, and the transmission analog signal is transmitted and supplied to the power source line 6 and further is supplied to the elevator monitor section through the power source line 6.

When the analog signal is supplied from the elevator monitor section through the power source line 6, on the other hand, the transmitter/receiver 4 receives this analog signal. When the reception analog signal is supplied at this time to the data reception portion 16 through the buffer portion 17, the data reception portion 16 executes analog/digital conversion of the reception analog signal, generates reception serial data and supplies the reception serial data so generated to the reception data processor 14. The reception data processor 14 executes data correction, etc, of the reception serial data supplied, and supplies the data to the multimedia access control portion 10. The multimedia access control portion 10 converts the reception serial data so supplied to stream data and supplies the stream data so converted to the digital data processor 9. The digital signal processor 9 converts the stream data supplied thereto to digital data having a transmission rate of several Mbps and supplies the digital data so converted to the digital/analog conversion portion 8. The digital/analog conversion portion 8 converts the digital data so supplied to an analog signal and supplies the resulting analog signal (speech signal) to the interphone 3. Receiving this analog signal (speech signal), the interphone 3 emits the speech signal.

According to the elevator signal transmission system described above, the power source line 6 is allowed to transmit the monitor signal and the communication signal that should be originally transmitted through the transmission line, and is used as the power source line 6 and also as the transmission line. Therefore, the transmission line need not be arranged in the line bundle and the total number of lines of the line bundle can be decreased as much. Because the transmission rate of the monitor signal and the communication signal to be transmitted through the power source line 6 is selected to be several Mbps in terms of bits, the monitor signal and the communication signal can be transmitted through the power source line 6 without lowering signal quality.

According to the invention described above, the monitor camera and the interphone equipped with the camera are connected to the power source line through the transmitter/receiver and the power source line is used also as the transmission line. In this case, the transmitter/receiver codes data of the transmission signals from the monitor camera and from the interphone equipped with the camera, allows the power source line to transmit the data, decodes the code data received from the power source line and supplies the data to the interphone equipped with the camera. Therefore, at least the transmission line can be omitted from the line bundle, and the production cost of the line bundle, that is, the production cost of the elevator, becomes lower as much, and high quality signal transmission can be conducted.

What is claimed is:

1. An elevator signal transmission system comprising:
a monitor camera and an interphone equipped with a camera, each arranged inside an elevator cage;
a power source line for supplying driving power to said cage; and
a transmitter/receiver provided to said cage, for connecting said monitor camera and said interphone equipped with the camera to said power source line;
wherein said transmitter/receiver causes said power source line to transmit transmission signals from said monitor camera and from said interphone equipped with the camera, and supplies reception signals received from said power source line to said interphone equipped with the camera.
